(19) United States
(12) Patent Application Publication
(10) Pub. No.: US 2015/0099616 A1
(43) Pub. Date: Apr. 9, 2015

(54) CONTAINER-FORMING PROCESS AND MACHINE

(71) Applicant: Berry Plastics Corporation, Evansville, IN (US)

(72) Inventors: Kody A. Chapman, Boonville, IN (US); Roy E. Ackerman, Evansville, IN (US); Chris K. Leser, Evansville, IN (US)

(21) Appl. No.: 14/506,906

(22) Filed: Oct. 6, 2014

Related U.S. Application Data
(60) Provisional application No. 61/887,091, filed on Oct. 4, 2013.
(60) Provisional application No. 61/892,294, filed on Oct. 17, 2013.

(51) Int. Cl. B31C 7/06; B31B 1/64; B31B 1/74; B31B 1/28

(52) U.S. Cl. CPC B31C 7/06; B31B 1/28; B31B 1/64; B31B 1/74
USPC 493/106; 493/133; 493/109

(57) ABSTRACT

A container-forming process is used to form an insulative container. The container-forming process includes a staging-materials operation, a body-forming operation, and a brim-forming operation.

### PRIORITY CLAIM

This application claims priority under 35 U.S.C. §119(e) to U.S. Provisional Application Ser. No. 61/887,091, filed Oct. 4, 2013 and U.S. Provisional Application Ser. No. 61/892,294, filed Oct. 17, 2013, each of which is expressly incorporated by reference herein.

### BACKGROUND

The present disclosure relates to a machine for forming containers, and in particular to insulated containers. More particularly, the present disclosure relates to a container-forming machine that uses a body blank and a floor blank to form an insulated container.

### SUMMARY

A container-forming process in accordance with the present disclosure produces an insulated container using a container-forming machine. The container-forming process includes forming a body included in the insulated container and forming a brim on the body to establish the insulated container. The body-forming operation uses a body blank and a floor blank to establish the body. The brim-forming operation uses the body formed during the body-forming operation and curls a top edge of the body out and down to establish a rolled brim on the body so that an insulated container is established.

In illustrative embodiments, a container-forming process in accordance with the present disclosure produces an insulative container from a body blank and a floor blank. Both the floor blank and the body blank are made from a sheet of insulative cellular non-aromatic polymeric material The container-making process further includes heating floor stock which is cut after heating to form a heated floor blank. The heated floor blank bends without fracturing and conforms with the body blank when the floor blank is mated with the body blank to form the body of a container and reduces the chance of leakage through and around the floor blank.

In illustrative embodiments, a floor-stock heater unit is configured to provide heat to the floor stock during the heating operation. The floor-stock heater unit includes a stock guide and a heater. The stock guide supports and guides a portion of the floor stock during heating and into a floor-blank cutter. The heater provides heat via radiative heat transfer to both sides of the floor stock so that a predetermined temperature of the floor stock is achieved prior to cutting the heated floor blanks.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagrammatic view of a container-forming process in accordance with the present disclosure showing that the container-forming process includes the operations of staging materials for use in a container-forming machine, forming a body included in an insulative container, and forming a brim to establish the insulative container in accordance with the present disclosure;

FIG. 2 is a diagrammatic view of the staging-materials operation showing that the staging-materials operation includes the operations of loading body blanks onto the container-forming machine, placing body blanks on a loading turret, and heating the body blanks and loading a floor-stock roll of material onto the container-forming machine, heating a portion of the floor stock, and cutting heated floor blanks from the heated portion of the floor stock;

FIG. 3 is a diagrammatic view of a first embodiment of a body-forming operation in accordance with the present disclosure showing that the body-forming operation includes forming a floor unit using the heated floor blank, forming a sleeve unit using the heated body blank, heating a floor-retaining flange included in the sleeve unit, heating a platform-support member included in the floor unit, and coupling the floor unit to the sleeve unit to produce the body of the insulative container;

FIG. 4 is a diagrammatic view of a second embodiment of a body-forming operation in accordance with the present disclosure showing that the body-forming operation includes forming a sleeve unit using the heated body blank, forming a floor unit using the heated floor blank, heating a floor-retaining flange included in the sleeve unit, heating a platform-support member included in the floor unit, and coupling the floor unit to the sleeve unit to produce the body of the insulative container;

FIG. 5 is a diagrammatic view of a heat-control system included in a container-forming machine showing that the heat-control system includes a controller, a power source coupled to the controller, and a sensor coupled to the controller and that the heat-control system is coupled to a stock-heater unit that heats the floor stock as controlled by the controller;

FIG. 6 is a perspective view of a first embodiment of a floor-stock heater unit in accordance with the present disclosure showing that the floor-stock heater unit includes a stock guide through which a portion of floor stock from a floor-stock roll is guided through and a set of heaters arranged to provide heat to both sides of the portion of the floor stock to cause the portion of the floor stock to have a predetermined temperature when the floor blank is cut;

FIG. 7 is a perspective view of second embodiment of a floor-stock heater unit in accordance with the present disclosure showing that the floor-stock heater unit includes a stock guide over which a portion of floor stock from a floor-stock roll moves prior to cutting, a heater arranged over a portion of the floor-stock guide to heat up the portion of floor stock, and a spring panel adapted to push the portion of floor stock into contact with the heater so that heat is transferred from the heater to the portion of floor stock;

FIG. 8 is a perspective view of an insulative container made from an insulative cellular non-aromatic polymeric material using the container-forming process shown in FIG. 1 showing that the insulative container includes a body and a floor;

FIG. 9 is an enlarged sectional view of a portion of a side wall included in the body of the insulative container of FIG. 8 showing that the side wall is made from the sheet that includes, from left to right, a skin including a film layer, an ink layer, and an adhesive layer, and the strip of insulative cellular non-aromatic polymeric material;

FIG. 10 is an exploded assembly view of the insulative container of FIG. 8 showing that the insulative container includes, from top to bottom, the body including a rolled brim, the side wall, and a floor mount configured to interconnect the floor and the side wall as shown in FIG. 8; and

FIG. 11 is a sectional view taken along line 11-11 of FIG. 8 showing that the side wall included in the body of the insulative container includes a generally uniform thickness and that the floor is coupled to the floor mount included in the body.

### DETAILED DESCRIPTION

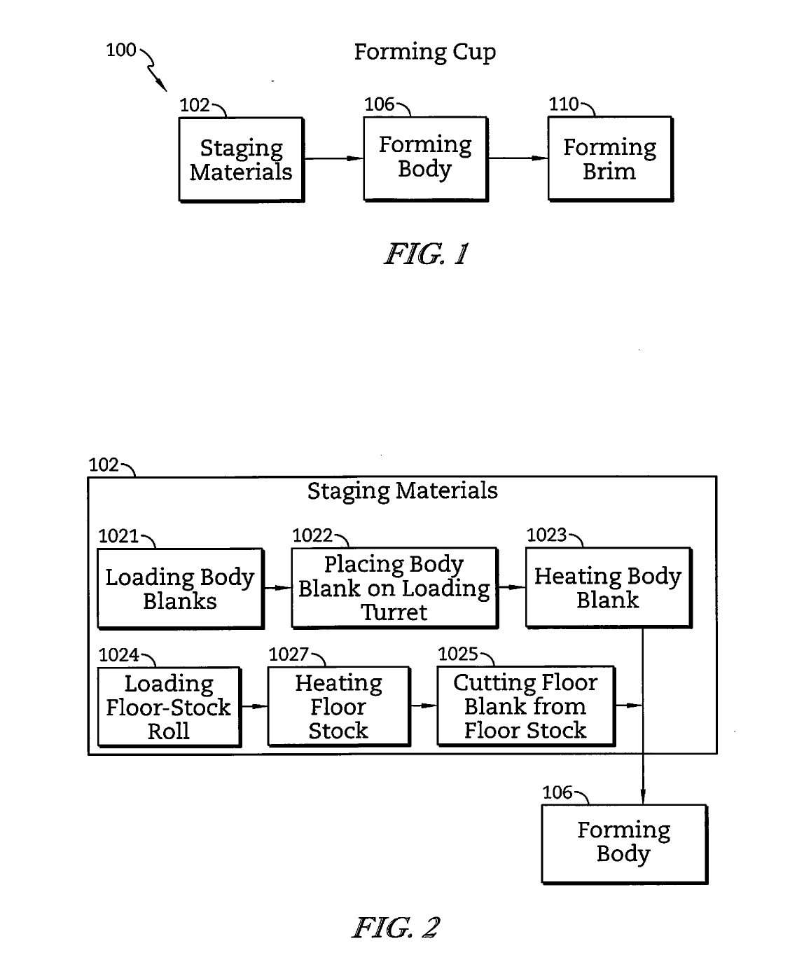

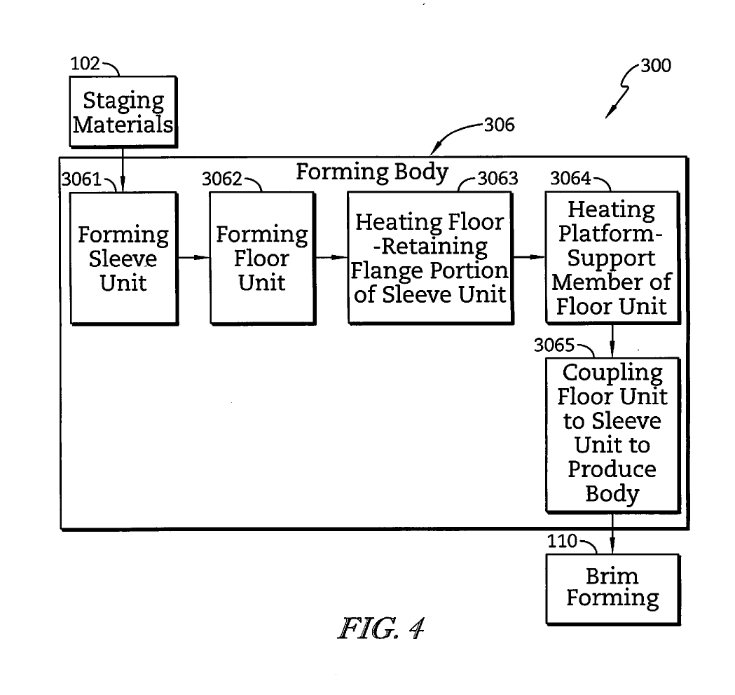

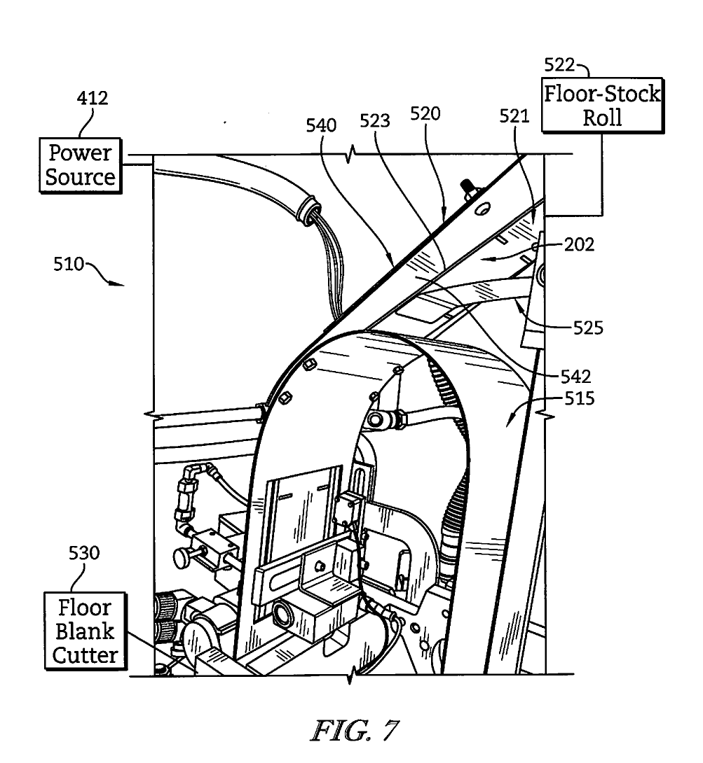

A first embodiment of a container-forming process 100 in accordance with the present disclosure is used to form an insulative container 10 as shown in FIGS. 1-3. A second embodiment of a container-forming process 300 in accordance with the present disclosure is shown FIG. 4. Each container-forming process 100, 300 includes a staging-materials operation 102 in which a heated floor blank and a heated body blank are provided to a container-forming machine where they are used to form insulative container 10. Heating of the floor blank may be accomplished using a first embodiment of a floor-stock heater unit 200 as shown in FIG. 6 or a second embodiment of a floor-stock heater unit 510 as shown in FIG. 7. The heated floor blank bends without fracturing and conforms to the body blank when the floor blank is mated with the body blank to form the body of a container. Chances of leakage around the resulting floor are minimized as a result.

A container-forming process 100 for producing an insulative container 10 in accordance with the present disclosure includes a staging-materials operation 102, a body-forming operation 106, and a brim-forming operation 110 as shown in FIG. 1. Staging-materials operation 102 includes a heating floor stock operation 1027 using a floor-stock heater unit 200 to produce heated floor blanks that are formed into a floor 20 of insulative container 10. Body-forming operation 106 forms a body 11 using a heated floor blank and a heated body blank. Brim-forming operation 110 forms a rolled brim 16 on body 11 to establish insulative container 10.

Heating floor stock operation 1027 provides for a heated floor blank that facilitates creation of floor 20 bent to conform with a corresponding body blank when insulative container 10 is formed. Floor blanks that are warmed in accordance with the present disclosure are also less likely to fracture during bending and assembly with body blanks. By conforming to the body blank and reducing the likelihood of fracture, warmed floor blanks reduce the chance of leakage from insulative container 10 through or around floor 20 of insulative container 10 created using the warmed floor blanks.

Staging-materials operation 102 includes a loading body blanks operation 1021, a placing body blanks operation 1022, a heating body blanks operation 1023, a loading floor-stock roll operation 1024, heating floor stock operation 1027, and a cutting floor blank operation 1025 as shown in FIG. 2. Loading body blanks operation 1021 provides a body blank to a container-forming machine. Placing body blanks operation 1022 then places the body blank on a loading which provides the body blank for use in body-forming operation 106. Heating body blanks operation 1023 then applies heat to each body blank to form a heated body blank. During loading body blanks operation 1021, loading floor-stock roll operation 1024 occurs in which a floor-stock roll of material is loaded onto the container-forming machine. Heating floor stock operation 1027 applies heat to a portion of the floor stock which has been unrolled from floor-stock roll. Cutting floor blank operation 1025 then cuts a heated floor blank from the heated portion of the floor stock.

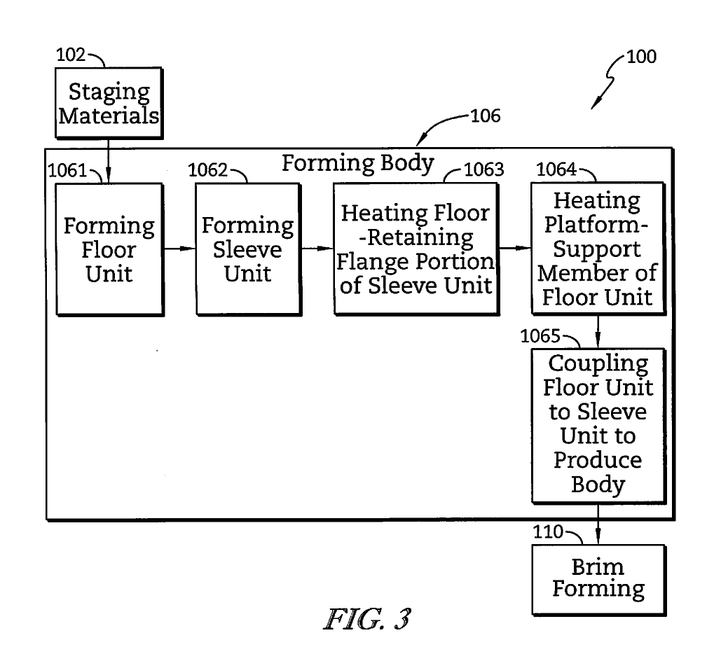

The heated floor blank and the heated body blank are then mated together during the subsequent body-forming operation 106 as shown in FIG. 3. By heating the floor stock to produce a heated floor blank, the floor blank conforms with the body blank during body-forming operation 106 and minimize leakage between floor 20 and body 11 in the finished insulative container 10.

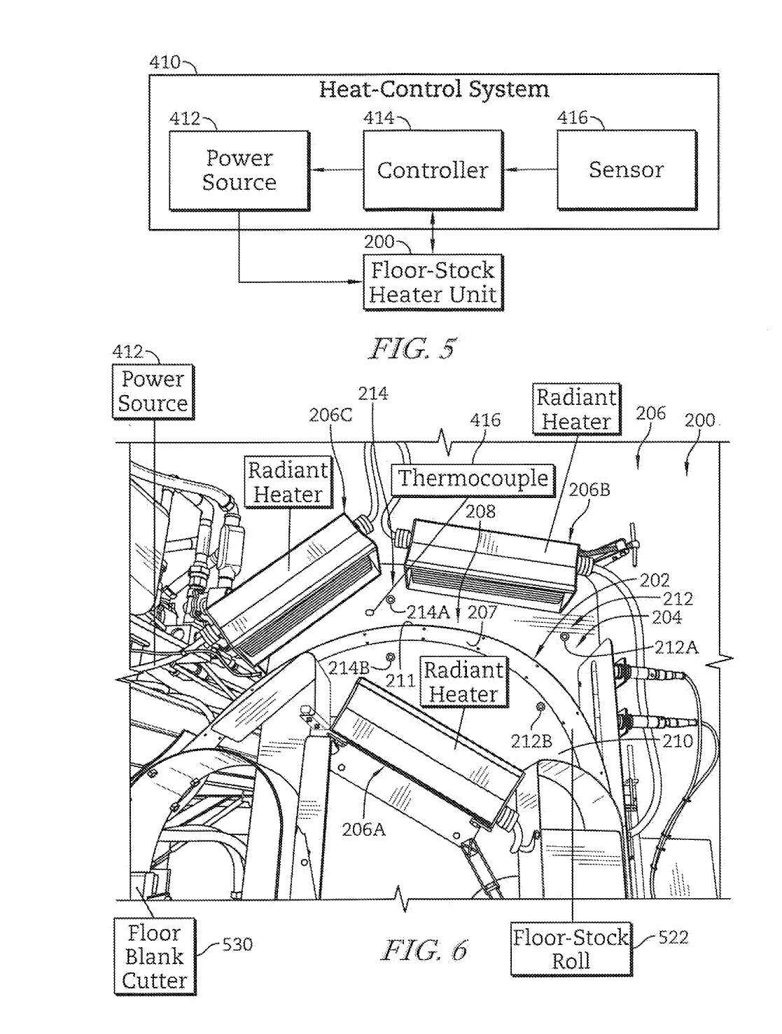

Heating floor stock operation 1027 uses a floor-stock heater unit 200 as suggested in FIG. 5 and shown in FIG. 6 to heat the portion 202 of the floor stock. Floor-stock heater unit 200 includes a stock guide 204 and a set 206 of heaters 206A, 206B, 206C as shown in FIG. 6. During container-forming process 100, portion 202 of the floor stock moves through stock guide 204. Stock guide 204 is configured to maintain the portion 202 of the floor stock within a range of predetermined distances from heaters 206A, 206B, 206C as shown in FIG. 6.

Heater 206A is arranged in spaced-apart relation below portion 202 of the floor stock and is configured to provide heat to a first side 207 of portion 202 as shown in FIG. 6. Heaters 206B, 206C are arranged in spaced-apart relation above portion 202 of the floor stock and are configured to provide heat to an opposite second side 211 of portion 202 of the floor stock. As portion 202 moves between upper heaters 206B, 206C and lower heater 206A, heat is transferred to both sides 207, 211 of portion 202 to cause portion 202 of the floor stock to have a predetermined temperature when the floor blank is cut.

Floor-stock heater unit 200 is coupled to a heat-control system 410 as suggested in FIG. 5. Heat-control system 410 includes a power source 412, a controller 414, and a sensor 416 as shown in FIG. 5. Power source 412 is coupled to controller 414 and configured to provide power to heaters 206A, 206B, 206C as commanded by controller 414. Sensor 416 is coupled to controller 414 and configured to provide temperature readings to controller 414. As shown in FIG. 6, sensor 416 is coupled to stock guide 204 and located adjacent to a stock space 208 formed in stock guide 204. Sensor 416 is configured to provide an indication of a temperature of the portion 202 being guided through stock guide 204 and heated by heaters 206A, 206B, 206C. Sensor 416 may also be located in stock space 208.

In one illustrative example, controller 414 includes a processor and memory. Instructions are stored on the memory and are executed by the processor to cause the desired temperature to be achieved as sensed by sensor 416. The instructions may include a control algorithm that causes power to be provided selectively to the heaters 206A, 206B, 206C so that the desired temperature is maintained. The control algorithm may cause an intensity of heat supplied by heaters 206A, 206B, 206C to change or to cause the heaters to modulate (turn off and on) so that the predetermined temperature is maintained.

The instructions may also include an algorithm that causes the heaters 206A, 206B, 206C to turn off when floor stock is not advancing at a predetermined rate through stock guide 204 so as to minimize damage to the floor stock. Damage may take the form of burning which is any interruption or destruction of the surface of the floor stock. Damage may also include burning which results in surface burns, unintended discoloration on the surface, or burns which extend through the floor stock. Damage may also include holes of about 0.001 inches or greater formed in the floor stock whether the holes extend completely through the floor stock or only part ways through the floor stock.

Stock guide 204 includes a guide foundation 210, a guide inlet 212, and a guide outlet 214 as shown in FIG. 6. Guide inlet 212 is coupled to guide foundation 210 and arranged to extend away from guide foundation 210 toward the portion 202 of the floor stock. Guide outlet 214 is coupled to guide foundation 210, arranged to extend away from guide foundation 210 toward the portion 202 of the floor stock, and be located in spaced-apart relation to guide inlet 212. Together guide foundation 210, guide inlet 212, and guide outlet 214 cooperate to define stock space 208. The portion 202 of the floor stock enters through guide inlet 212, moves through stock space 208, and exits through guide outlet 214. The portion 202 of the floor stock while passing through stock guide 204 is heated before entering a floor-blank cutter 530.

Guide inlet 212 includes a first inlet rod 212A and a second inlet rod 212B located in spaced-apart relation to one another to locate the portion 202 therebetween. Guide outlet 214 includes a first outlet rod 214A and a second outlet rod 214B located in spaced-apart relation to one another to locate the portion 202 therebetween. During advancement of the portion 202 of the floor stock, first inlet rod 212A and first outlet rod 214A cooperate to block the portion 202 from engaging first heater 206A. Also during advancement of the portion 2020, second inlet rod 212B and second outlet rod 214B cooperate to block the portion 202 from engaging second and third heaters 206B, 206C.

Sensor 416 is coupled to guide foundation 210 in a fixed position relative to guide foundation 210. Sensor 416 is positioned to locate guide outlet 214 between sensor 416 and guide inlet 212 as shown in FIG. 6.

In one example, each heater 206A, 206B, 206C is an infrared heater. The infrared heater provides heat primarily through radiative heat transfer. Each infrared heater is, for example, a 400 Watt heater.

After the body blank is heated and the heated floor blank is cut, container-forming process 100 proceeds to a body-forming operation 106. Body-forming operation 106 includes a forming a floor unit operation 1061, forming a sleeve unit operation 1062, a first heating operation 1063, a second heating operation 1064, and a coupling operation 1065 as shown in FIG. 3. Forming a floor unit operation 1061 forms a floor unit using a heated floor blank provided in staging-materials operation 102. Forming a sleeve unit operation 1062 forms a sleeve unit using a body blank provided in staging-materials operation 102. First heating operation 1063 applies heat to a floor-retaining flange included in sleeve unit. Second heating operation 1064 applies heat to platform-support member included in floor unit. Coupling operation 1065 couples floor-retaining flange to platform-support member to form a body 11 included in the insulative container 10. In one example, heating operations 1063 and 1064 may be performed in series or parallel to one another.

Another embodiment of a body-forming operation 106 includes a forming a sleeve unit operation 2061, forming a floor unit operation 2062, a first heating operation 2063, a second heating operation 2064, and a coupling operation 2065 as shown in FIG. 4. Forming a sleeve unit operation 2061 forms sleeve unit using the body blank provided in staging-materials operation 102. Forming a floor unit operation 2062 forms the floor unit using the floor blank provided in staging-materials operation 102. First heating operation 2063 applies heat to floor-retaining flange included in sleeve unit. Second heating operation 2064 applies heat to platform-support member included in floor unit. Coupling operation 1065 couples floor-retaining flange to platform-support member to form a body included in the insulative container. In one example, heating operations 2063 and 2064 may be performed in series or parallel to one another.

In some embodiments, a staging-materials operation in accordance with the present disclosure may include a pre-heating operation used with another embodiment of floor-stock heater unit 510. The pre-heating operation may be performed prior to the heating the floor stock operation and cause a heater 520 included in floor-stock heater unit 510 to be preheated to a pre-heat temperature of about 200 degrees Fahrenheit (° F.).

Floor-stock heater unit 510 is shown, for example, in FIG. 7. Floor-stock heater unit 510 includes a stock guide 515, a heater 520, and a spring panel 525 as shown in FIG. 7. Stock guide 515 is arranged to underlie portion 202 of the floor stock and supports/guides portion 202 from the floor-stock roll 522 toward a floor-blank cutter 530. Heater 520 is arranged over the portion 202 of the floor stock and heats a top side 523 of the portion 202 prior to floor blanks being cut from the heated portion of the floor stock by the floor-blank cutter 530. Spring panel 525 is arranged under the portion 202 of the floor stock and pushes the portion 202 of the floor stock upwardly into contact with the heater 520 so that heat is transferred from the heater 520 to the top side 523 of the portion 202 of the floor stock in accordance with the present disclosure via conductive heat transfer.

In one illustrative example, the floor stock includes a sheet of insulative cellular non-aromatic polymeric material and a printed film which has been laminated to one side of the sheet. In an example of use, the floor stock is fed through floor-stock heater unit 510 in an orientation selected to cause the printed film to be located between the sheet and the stock guide 515. As a result, the sheet is located between heater 520 so that heat supplied by heater 520 is provided directly to the sheet and the printed film is shielded by the sheet from direct application of heat in accordance with the present disclosure thereby minimizing damage to the printed film from the heat.

Heater 520 includes a resistive heating element 540 coupled to power source 412 and a heat-dispersion plate 542 as shown in FIG. 7. Resistive heating element 540 is heated when power is provided by power source 412. Heat-dispersion plate 542 is in contact with resistive heating element 540 and with the portion 202 of the floor stock and distributes heat from the heating element 540 to the portion 202 substantially evenly over the area of the top side 523 of the portion of the floor stock via conductive heat transfer. In one example, resistive heating element has a heat output of about 1,200 Watts.

A floor-stock heater unit in accordance with the present disclosure may include a source of heated air and one or more air nozzles coupled to the source of heated air. The nozzle(s) may be configured to apply the heated air to one or both sides of the portion 202 of the floor stock to transfer heat via convective heat transfer.

In another illustrative example, the floor stock includes only the sheet of insulative cellular non-aromatic polymeric material. In another illustrative example, the floor stock includes only a film.

Insulative container 10 includes, for example, a body 11 having a sleeve-shaped side wall 18 and a floor 20 as shown in FIGS. 15, 17, and 18. Floor 20 is coupled to body 11 and cooperates with side wall 18 to form an interior region 14 therebetween for storing food, liquid, or any suitable product. Body 11 also includes a rolled brim 16 coupled to an upper end of side wall 18 and a floor mount 17 coupled to a lower end of side wall 18 and to floor 20 as shown in FIG. 11.

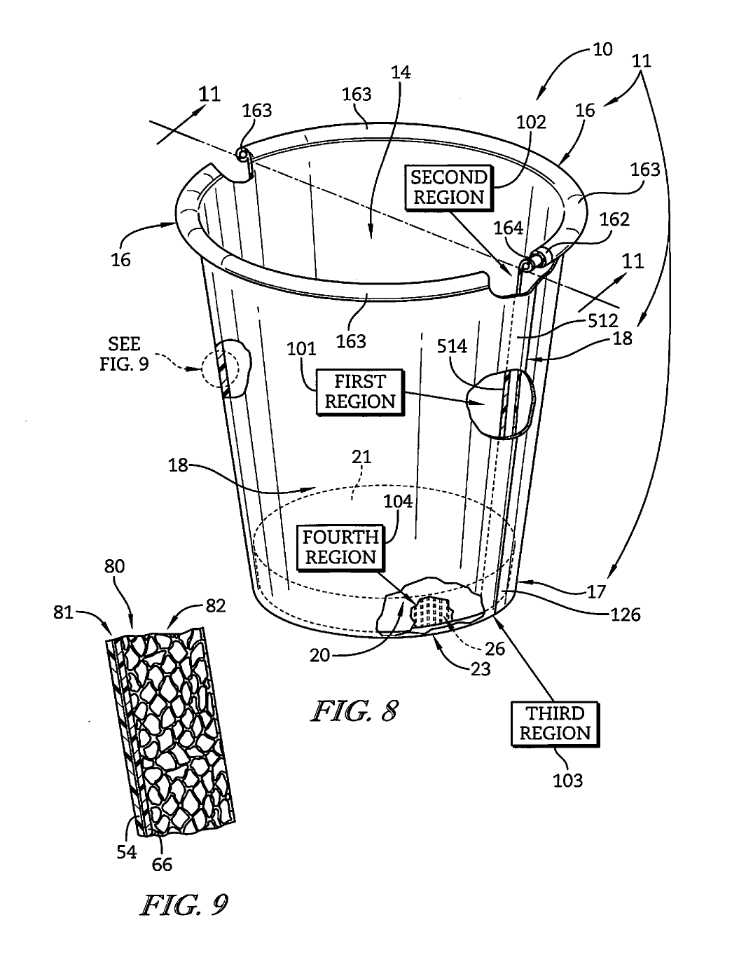

Insulative cellular non-aromatic polymeric material is configured in accordance with the present disclosure to provide means for enabling localized plastic deformation in at least one selected region of body 11 (e.g., side wall 18, rolled brim 16, floor mount 17, and a floor-retaining flange 26 included in floor mount 17) to provide (1) a plastically deformed first material segment having a first density in a first portion of the selected region of body 11 and (2) a second material segment having a relatively lower second density in an adjacent second portion of the selected region of body 11 as suggested, for example, in FIGS. 8, 10, and 11. In illustrative embodiments, the first material segment is thinner than the second material segment.

Insulative container 10 is made of a multi-layer sheet 80 as suggested in FIG. 1. Multi-layer sheet 80 comprises a strip 82 of insulative cellular non-aromatic polymeric material laminated with a skin having film layer 54 and ink layer 66 printed on film layer 54 to provide a container having high-quality graphics as suggested, for example, in FIG. 1.

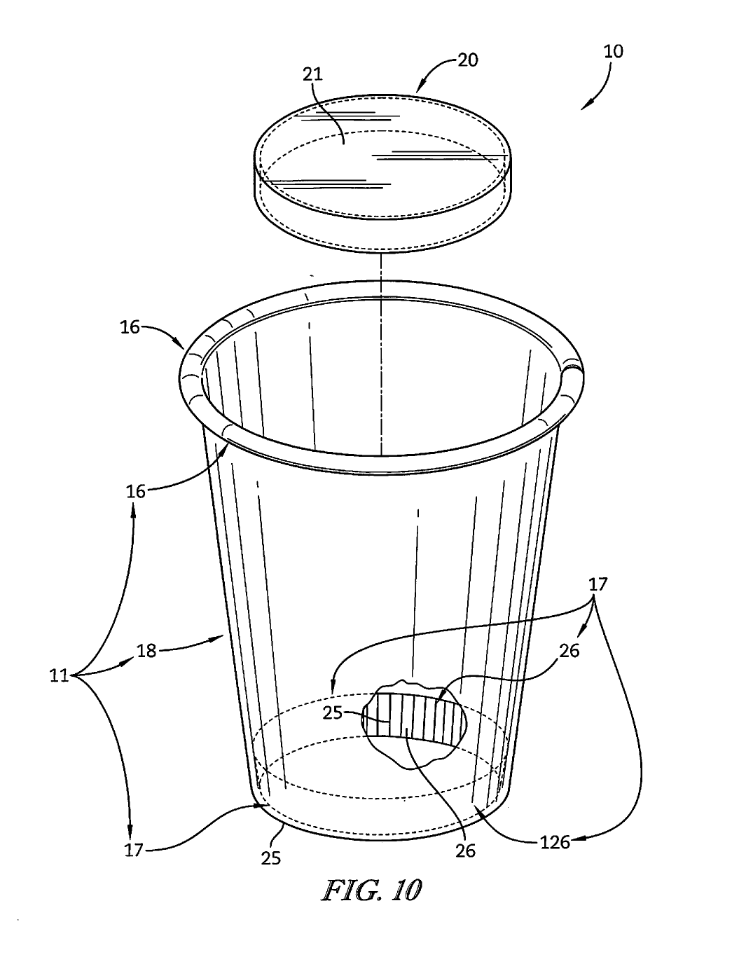

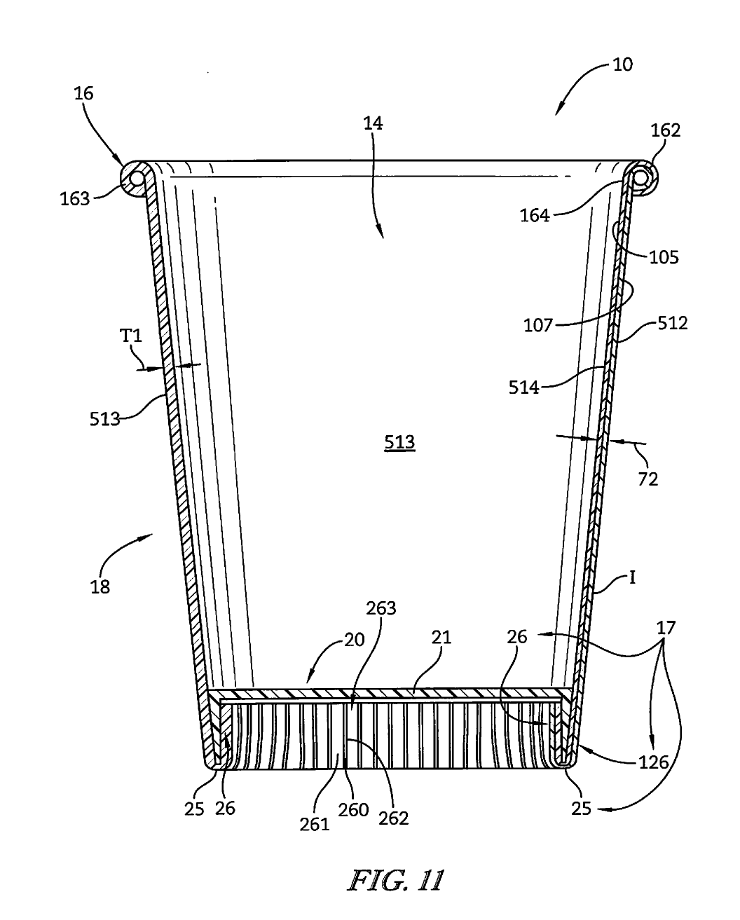

Film layer 54 is then printed with an ink layer 66. As an example, ink layer 66 includes graphics and the graphics are shown on insulative container 10 as a pair of triangles in FIG. 10.

An insulative cellular non-aromatic polymeric material produced in accordance with the present disclosure can be formed to produce an insulative container 10. As an example, the insulative cellular non-aromatic polymeric material comprises a polypropylene base resin having a high melt strength, a polypropylene copolymer or homopolymer (or both), and cell-forming agents including at least one nucleating agent and a blowing agent such as carbon dioxide. As a further example, the insulative cellular non-aromatic polymeric material further comprises a slip agent. The polypropylene base resin has a broadly distributed unimodal (not bimodal) molecular weight distribution.

Insulative cellular non-aromatic polymeric material is used during container-forming process 100 to make insulative container 10 as suggested in FIGS. 1-4. Reference is hereby made to U.S. application Ser. No. 13/491,007 filed Jun. 7, 2012 and titled INSULATED CONTAINER for disclosure relating to an insulative container made from an insulative cellular non-aromatic polymeric material, which application is hereby incorporated by reference in its entirety herein. Reference is hereby made to U.S. application Ser. No. 13/491,327 filed Jun. 7, 2012 and titled POLYMERIC MATERIAL FOR AN INSULATED CONTAINER and U.S. application Ser. No. 14/462,073 filed Aug. 18, 2014 and titled POLYMERIC MATERIAL FOR AN INSULATED CONTAINER for disclosure relating to such insulative cellular non-aromatic polymeric material, each of which is hereby incorporated by reference in its entirety herein.

An unexpected property of multi-layer sheet 80 including strip 82 of insulative cellular non-aromatic polymeric material is its ability when bent to form a round article, such as insulative container 10. Surface 105 is wrinkle free as is surface 107 as shown in FIG. 11. The roughness of the surfaces 105 and 107 of the present disclosure is such that the depth of creases or wrinkles naturally occurring when subjected to extension and compression forces during container-forming process 100 is less than about 100 microns and even less than about 5 microns in most instances. At less than about 10 microns, the creases or wrinkles are not visible to the naked eye.

In addition to surface topography and morphology, another factor that was found to be beneficial to obtain a high quality insulative container free of creases was the anisotropy of the insulative cellular non-aromatic polymeric strip. Aspect ratio is the ratio of the major axis to the minor axis of the cell. As confirmed by microscopy, in one exemplary embodiment the average cell dimensions in a machine direction (machine or along the web direction) of an extruded strip 82 of insulative cellular non-aromatic polymeric material was about 0.01954 inches (0.50 mm) in width by about 0.00853 inches (0.22 mm) in height. As a result, a machine direction cell size aspect ratio is about 2.29. The average cell dimensions in a cross direction (cross-web or transverse direction) was about 0.01845 inches (0.47 mm) in width and about 0.00828 inches (0.21 mm) in height. As a result, a cross-direction aspect ratio is about 2.23. In one exemplary embodiment, it was found that for the strip to withstand compressive force during container forming; one desirable average aspect ratio of the cells was between about 1.0 and about 3.0. In one exemplary embodiment one desirable average aspect ratio of the cells was between about 1.0 and about 2.0.

The ratio of machine direction to cross direction cell length is used as a measure of anisotropy of the extruded strip. In exemplary embodiments, a strip of insulative cellular non-aromatic polymeric material may be bi-axially oriented, with a coefficient of anisotropy ranging between about 0.1 and about 3. In one exemplary embodiment, the coefficient of anisotropy was about 1.1.

If the circumference of the container is aligned with machine direction of strip 82 with a cell aspect ratio exceeding about 3.0, deep creases with depth exceeding about 200 microns are typically formed on an inside surface of the container making it unusable. Unexpectedly, it was found, in one exemplary embodiment, that if the circumference of the container was aligned in the cross direction of extruded strip 82, which can be characterized by cell aspect ratio below about 2.0, no deep creases were formed inside of the container, indicating that the cross direction of strip 82 was more resistant to compression forces during container formation.

One possible reason for greater compressibility of an extruded strip with cells having aspect ratio below about 2.0 in the direction of container circumference, such as in the cross direction, could be due to lower stress concentration for cells with a larger radius. Another possible reason may be that the higher aspect ratio of cells might mean a higher slenderness ratio of the cell wall, which is inversely proportional to buckling strength. Folding of the strip into wrinkles in the compression mode could be approximated as buckling of cell walls. For cell walls with longer length, the slenderness ratio (length to diameter) may be higher. Yet another possible factor in relieving compression stress might be a more favorable polymer chain packing in cell walls in the cross direction allowing polymer chain re-arrangements under compression force. Polymer chains are expected to be preferably oriented and more tightly packed in machine direction.

In exemplary embodiments, cell aspect ratio is about 2.0 when the formed container circumference is aligned in the direction of extruded strip. As a result, the surface of extruded strip with crystal domain size below about 100 angstroms facing inside the container may provide favorable results of achieving a desirable surface topography with imperfections less than about 5 microns deep.

In one aspect of the present disclosure, the polypropylene resin (either the base or the combined base and secondary resin) may have a density in a range of about 0.01 g/cm³ to about 0.19 g/cm³. In one exemplary embodiment, the density may be in a range of about 0.05 g/cm³ to about 0.19 g/cm³. In one exemplary embodiment, the density may be in a range of about 0.1 g/cm³ to about 0.185 g/cm³.

It has been found during development of the present disclosure that if the circumference of insulative container 10 is aligned with the machine direction of strip 82 of insulative cellular non-aromatic polymeric material, deep creases with a depth in excess of about 200 microns are typically formed on surface 107. Unexpectedly, it has been determined that if the circumference of insulative container 10 is aligned generally perpendicular to machine direction, the formation of deep creases on surface 107 may be lessened to some extent, indicating that the cross-direction to the machine direction of extruded insulative cellular non-aromatic polymeric material is resistant to compression forces during formation of insulative container 10. It is believed that this is a result of the orientation of the polymer chains of extruded insulative cellular non-aromatic polymeric material which are oriented and more tightly packed in machine direction.

Body 11 is formed from a strip 82 of insulative cellular non-aromatic polymeric material as disclosed herein. In accordance with the present disclosure, strip 82 of insulative cellular non-aromatic polymeric material is configured through application of pressure and heat (though in exemplary embodiments configuration may be without application of heat) to provide means for enabling localized plastic deformation in at least one selected region of body 11 to provide a plastically deformed first sheet segment having a first density located in a first portion of the selected region of body 11 and a second sheet segment having a second density lower than the first density located in an adjacent second portion of the selected region of body 11 without fracturing the sheet of insulative cellular non-aromatic polymeric material so that a predetermined insulative characteristic is maintained in body 11.

Sleeve-shaped side wall 18 includes an upright inner tab 514, an upright outer tab 512, and an upright fence 513 as suggested in FIG. 11. Upright inner tab 514 is arranged to extend upwardly from floor 20 and configured to provide the first sheet segment having the first density in the first 101 of the selected regions of body 11. Upright outer tab 512 is arranged to extend upwardly from floor 20 and to mate with upright inner tab 514 along an interface I therebetween as suggested in FIG. 9. Upright fence 513 is arranged to interconnect upright inner and outer tabs 514, 512 and surround interior region 14. Upright fence 513 is configured to provide the second sheet segment having the second density in the first 101 of the selected regions of body 11 and cooperate with upright inner and outer tabs 514, 512 to form sleeve-shaped side wall 18 as suggested in FIGS. 15, 17, and 18.

Rolled brim 16 is coupled to an upper end of sleeve-shaped side wall 18 to lie in spaced-apart relation to floor 20 and to frame an opening into interior region 14. Rolled brim 16 includes an inner rolled tab 164, an outer rolled tab 162, and a rolled lip 163 as suggested in FIGS. 15, 17, and 18. Inner rolled tab 164 is configured to provide the first sheet segment in the second 102 of the selected regions of body 11. Inner rolled tab 164 coupled to an upper end of upright outer tab 512 included in sleeve-shaped side wall 18. Outer rolled tab 162 is coupled to an upper end of upright inner tab 514 included in sleeve-shaped side wall 18 and to an outwardly facing exterior surface of inner rolled tab 164. Rolled lip 163 is arranged to interconnect oppositely facing side edges of each of inner and outer rolled tabs 164, 162. Rolled lip 163 is configured to provide the second sheet segment having the second density in the second 102 of the selected region of body 11 and cooperate with inner and outer rolled tabs 164, 162 to form rolled brim 16 as suggested in FIG. 8.

Floor mount 17 is coupled to a lower end of sleeve-shaped side wall 18 to lie in spaced-apart relation to rolled brim 16 and to floor 20 to support floor 20 in a stationary position relative to sleeve-shaped side wall 18 to form interior region 14. Floor mount 17 includes a web-support ring 126, a floor-retaining flange 26, and a web 25. Web-support ring 126 is coupled to the lower end of sleeve-shaped side wall 18 and configured to provide the second sheet segment having the second density in the third 103 of the selected regions of body 11. Floor-retaining flange 26 is coupled to floor 20 and arranged to be surrounded by web-support ring 126. Web 25 is arranged to interconnect floor-retaining flange 26 and web-support ring 126. Web 25 is configured to provide the first sheet segment having the first density in the third 103 of the selected regions of body 11.

Floor-retaining flange 26 includes an alternating series of upright thick and thin staves arranged in side-to-side relation to extend upwardly from web 25 toward interior region 14 bounded by sleeve-shaped side wall 18 and floor 20. A first 261 of the upright thick staves is configured to include a right side edge extending upwardly from web 25 toward interior region 14. A second 262 of the upright thick staves is configured to include a left side edge arranged to extend upwardly from web 25 toward interior region 14 and lie in spaced-apart confronting relation to right side edge of the first 261 of the upright thick staves. A first 260 of the upright thin staves is arranged to interconnect left side edge of the first 261 of the upright thick staves and right side edge of the second 262 of the upright thick staves and to cooperate with left and right side edges to define therebetween a vertical channel 263 opening inwardly into a lower interior region bounded by floor-retaining flange 26 and a horizontal platform 21 included in floor 20 and located above floor-retaining flange 26. The first 260 of the upright thin staves is configured to provide the first sheet segment in the fourth 104 of the selected regions of body 11. The first 261 of the upright thick staves is configured to provide the second sheet segment in the fourth 104 of the selected regions of the body 11.

1. A container-forming process for forming an insulative container, the container-forming process comprising the steps of
staging a body blank,
providing floor stock including a strip of insulative cellular non-aromatic polymeric material,
heating a portion of the floor stock to provide a heated portion,
cutting the heated portion to provide a heated floor blank,
using the heated floor blank to form a floor unit without fracturing the floor unit,
using the body blank to form a sleeve unit,
coupling the floor unit to the sleeve unit to establish a body, and
forming a brim on the body unit to establish an insulative container.

2. The container-forming process of claim 1, wherein the heated portion has a temperature in a range of about 130 degrees Fahrenheit to about 150 degrees Fahrenheit during the heating step.

3. The container-forming process of claim 2, wherein the heated portion has a temperature in a range of about 110 degrees Fahrenheit to about 130 degrees Fahrenheit after the heating step and prior to cutting step.

4. The container-forming process of claim 3, wherein the heated portion has a temperature of about 120 degrees Fahrenheit after the heating step and prior to the cutting step.

5. The container-forming process of claim 4, wherein the heating step is performed without burning the portion of the floor stock.

6. The container-forming process of claim 1, wherein the heating step is performed without burning the portion of the floor stock.

7. The container-forming process of claim 1, wherein the heating step includes the steps of providing a stock-heater unit configured to provide heat and transferring heat from the stock-heater unit to the portion of the floor stock.

8. The container-forming process of claim 7, wherein the transferring step is performed via conductive heat transfer.

9. The container-forming process of claim 8, wherein the heat is transferred to a first side of the portion of the floor stock.

10. The container-forming process of claim 7, wherein the transferring step is performed via convective heat transfer.

11. The container-forming process of claim 7, wherein the transferring step is performed via radiative heat transfer.

12. The container-forming process of claim 7, wherein the transferring step includes the step of applying a first amount of heat to a first side of the portion of the floor stock.

13. The container-forming process of claim 12, wherein the transferring step further includes the step of applying a second amount of heat to an opposite second side of the portion of the floor stock.

14. The container-forming process of claim 13, wherein the second amount of heat is greater than the first amount of heat.

15. The container-forming process of claim 14, wherein the second amount of heat is about twice the first amount of heat.

16. The container-forming process of claim 15, wherein the transferring step is performed via radiative heat transfer.

17. The container-forming process of claim 1, wherein the heating step includes the steps of providing a stock-heater unit configured to provide heat, applying a first amount of heat to a first side of the portion of the floor stock, and applying a relatively greater second amount of heat to an opposite second side of the portion of the floor stock, and wherein the heated portion has a temperature in a range of about 130 degrees Fahrenheit to about 150 degrees Fahrenheit during the heating step.

18. The container-forming process of claim 17, wherein the heated portion has a temperature in a range of about 110 degrees Fahrenheit to about 130 degrees Fahrenheit after the heating step and prior to cutting step.

19. The container-forming process of claim 18, wherein the heating step is performed without burning the portion of the floor stock.
